(19) United States
(12) Patent Application Publication
(10) Pub. No.: US 2001/0043266 A1
(43) Pub. Date: Nov. 22, 2001

(54) Method and apparatus for viewing stereoscopic three- dimensional images

(76) Inventors: Kerry Robinson, Los Gatos, CA (US); John D. Fergason, Redwood City, CA (US)

Correspondence Address: Warren A. Sklar, Renner, Otto, Boisselle & Sklar, L.L.P., 19th Floor, 1621 Euclid Avenue, Cleveland, OH, 44115, US

(21) Appl. No.: 09/776,185

(22) Filed: Feb. 2, 2001

Related U.S. Application Data
(60) Provisional application No. 60/179,889, filed on Feb. 2, 2000.

(51) Int. Cl. H04N 9/47

(52) U.S. Cl. 348/53

(57) ABSTRACT

A display system 10 including liquid crystal eyewear 22 for producing a three dimensional (3-D) or stereoscopic image (i.e., an image having depth) is provided by liquid crystal shutters (41L, 41R) in the liquid crystal eyewear which are used to view two dimensional images. The shutter alternates between transmissive and non-transmissive states in order to present different images to the right and left eyes thereby presenting the viewer with a three dimensional image. The synchronization and coordination of the shutters includes a delay (65, tₛ) to accommodate the switching time and latency of the liquid crystal eyewear and signal transmission. The liquid crystal eyewear may be connected into the display system in a wired (12a) or wireless (12b) manner. Wireless connection can be made with infrared light emitting diodes (21b, 21c, 71) transmitting infrared light to the eyewear. The infrared light generated is sufficiently spaced apart and has a duration sufficiently short to avoid interfering with other infrared equipment such a remote controls that use infrared signals lasting hundreds of milliseconds.

### TECHNICAL FIELD

This invention relates, generally, to method and apparatus for viewing stereoscopic three-dimensional images, and, more particularly, to such method and apparatus with versatility for viewing such images using a variety of display and coordination techniques and display systems.

### BACKGROUND

In general an individual uses both eyes to view objects or images. Due to the separation of our eyes, each eye views the world from a slightly different vantage point. The two views are combined by the human brain to allow a person to perceive depth or three dimensions (hereinafter sometimes referred to as stereo or 3D).

Computer displays, televisions, electronic game displays and movie screens have no depth. Thus, when viewing a computer or game display, television, or a movie screen, both of an individual's eyes see substantially the same image and there is no depth perception, that is, the individual does not perceive three dimensions in the image being viewed. Rather, the image seen is two dimensional (hereinafter sometimes referred as 2D or planar).

The art of presenting different images to the left and right eye of a viewer so that the viewer perceives a 3D image (sometimes referred to as stereoscopic or stereo image) is well developed. Different images can be presented to each eye of a viewer using special eye glasses which select or distinguish between respective left and right eye images or views. One early system utilized polarized glasses, the respective lenses of which pass vertically polarized light to one eye and horizontally polarized light to the other eye. When a viewer is wearing such glasses and correctly polarized images are displayed on a display or projected onto a screen, etc., the viewer can perceive (e.g., see) a 3D image. Other types of eye glasses to distinguish between images used color filter techniques, circularly polarized light or other means to effect desired selection.

Other known selection systems utilize eye glasses or goggles which have lenses that can be electronically opened and closed, for example, as light shutters. As the respective left and right lenses (light shutters) are alternatively opened and closed and appropriate left eye and right eye images are alternatively projected onto a screen or shown in a display in time sequence synchronized with the opening and closing of the lenses, 3D images can be seen (perceived) by the user. For convenience, devices to distinguish or to select between left and right eye images for viewing may be referred to below collectively and equivalently as eye glasses, shutters, shutter glasses, etc.

There are several types of display systems or modes of display operation that utilize such shutter glasses to provide left and right eye images for 3D viewing. Examples are, as follows:

a. One system uses an above and below format in which all of the left eye display image or information is found in either the top or bottom half of each frame or field of an image file (in some display techniques a frame of an image is composed of two sequentially displayed fields), and the right eye image or information is found at the other half of the image file. The left and right eye images derived from image data in the image file are displayed sequentially. Each image usually is expanded so it appears as a full screen image. Various image expanding techniques are known. A similar system has the left and right eye image information displayed, respectively on the left and right halves of the display and appropriate image expanding techniques may be used to fill the respective images on the screen for viewing by respective eyes as each image is sequentially shown.

b. A second system is generally referred to as an “interleaved system”. Interleaved systems image files contain one eye image data in the odd numbered lines of each field of a two field frame, and the other eye image data in the even numbered lines of that field. (If the frame only has one field, for example, then the odd and even numbered lines of the frames would be used, etc.) A first image is displayed using the data from the odd numbered lines of each field of the image and then a second image is displayed using the data from the even numbered lines. As the images are shown on the display, one shutter, e.g., the left eye shutter of the eye glasses, is opened for one image and closed for the second image; and the other shutter, e.g., the right eye shutter of the eye glasses, is opened for the second image and closed for the first image.

c. A third system displays images in what is sometimes called “page flip” mode. In a page flip system the image file is organized so that one field of a frame contains left eye image data and the other field contains right eye image data. Left and right eye images are alternatively shown on the display as respective fields of frames of data are provided from the image file.

Various techniques are used to store image information as data in files, such as digital files, sometimes referred to as graphic files or image files. Several standard techniques and graphic file formats resulting therefrom lead to graphic files known as JPEG (sometimes referred to as JPG), GIF, BMP, TIF, and others; such files usually have a “dot suffix” in their name identification, such as, .JPG, .GIF, .BMP, .TIF, etc. Other standard techniques and formats include Apple Quicktime movies and RealNetworks RealPlayer movies. These standard techniques and formats are exemplary, and there may be others now in existence or developed in the future.

A graphics file for displaying 3D images contains image information for both the left eye and right eye images or views or, in a computational system the image information for one eye view and information concerning a computational algorithm to prepare the other eye view.

Images can be displayed on a computer monitor, television, or other display or can be projected. For 3D images to be displayed or projected usually specialized hardware and software is needed to display the images and to coordinate and to synchronize the eye glasses with the respective left/right images being displayed. Prior systems have required substantial circuitry, control systems, control boxes, power supplies and the like to provide power to the shutter eye glasses and to provide such coordination and synchronization. Accordingly, there is a need in the art to reduce the size, to improve the efficiency and to reduce costs of such systems.

Prior 3D viewing systems usually were specially designed to work in a single environment, e.g., a computer and monitor/display environment or a television display environment or with a special display system, such as a video game or other 3D viewing system. Upon changing to a different display system, whether an upgrade or that of a different vendor, typically it was necessary in the past also to acquire a new shutter glasses system and controller for power, coordination and synchronization therefor. Also, some prior shutter glasses systems and controllers were designed for specific use with a computer monitor or for specific use with a television. Accordingly there is a need in the art for improved versatility for such shutter eye glasses and controllers therefor.

### SUMMARY

Briefly, according to an aspect of the invention, a stereoscopic liquid crystal eyewear system includes liquid crystal eyewear for viewing an image; and an electronic circuit including a coordination circuit portion and a transmitter circuit portion, wherein the coordination circuit portion provides a delay to accommodate the switching time and latency of the liquid crystal eyewear, and wherein the transmitter circuit portion generates a signal for transmission to the liquid crystal eyewear.

Another aspect relates to a method of controlling stereoscopic liquid crystal eyewear, including periodically altering a transmissive state of the stereoscopic eyewear, a timing of the periodically altering the transmissive state of the stereoscopic eyewear corresponding to a first synchronizing signal; monitoring a second synchronizing signal to determine a period of the second synchronization signal; subtracting a latency of the liquid crystal eyewear from the period to determine a switching interval; and transmitting a first synchronizing signal to control the timing of the periodically altering of the periodically altering the transmissive state of the stereoscopic eyewear, wherein the first synchronizing signal is determined in accordance with the switching interval.

According to another aspect, a control circuit for controlling light shutters used to view stereoscopic images includes a signal source providing a synchronizing signal representative of the presenting of left and right eye images for selective viewing to provide a stereoscopic view, and a time shifter to shift the timing of the synchronizing signal to compensate for latency characteristics.

According to another aspect, a viewing system for viewing a sequence of left eye images and right eye images to provide a stereoscopic view, includes light shutters for sequentially transmitting sequential images for viewing, respectively, by a left eye and right eye of a user, and a control circuit for controlling light shutters used to view stereoscopic images includes a signal source providing a synchronizing signal representative of the presenting of left and right eye images for selective viewing to provide a stereoscopic view, and a time shifter to shift the timing of the synchronizing signal to compensate for latency characteristics.

According to another aspect, a circuit for supplying signals to operate shutters sequentially to provide selective transmission and blocking of images for sequential viewing to provide a stereoscopic images includes a controller producing a time shifted periodic signal based on an input synchronization signal, a multiplexer/demultiplexer responsive to an output from the controller for sequentially providing power signals to operate respective shutters for such viewing stereoscopic images.

According to another aspect, a viewing system for viewing a sequence of left eye images and right eye images to provide a stereoscopic view, comprising light shutters for sequentially transmitting sequential images for viewing, respectively, by a left eye and right eye of a user, and a circuit for supplying signals to operate shutters sequentially to provide selective transmission and blocking of images for sequential viewing to provide a stereoscopic images includes a controller producing a time shifted periodic signal based on an input synchronization signal, a multiplexer/demultiplexer responsive to an output from the controller for sequentially providing power signals to operate respective shutters for such viewing stereoscopic images.

According to another aspect, a modular system for viewing stereoscopic images is characterized in that an image source provides sequentially images for viewing respectively by the respective eyes of a viewer to create the impression of a stereoscopic view, selectively operable shutters to transmit or to prevent transmission of images, a signal source provides synchronization signal for synchronizing the shutters, and a wired or wireless connection is provided to the shutters for operation thereof in response to such synchronization.

According to another aspect, apparatus for providing signals to synchronize light shutters for viewing of stereoscopic images from a video source, includes a device to obtain field information from a video signal provided by a video source, wherein such field information provides coordination to the particular field of a multiple field image for display, a controller responsive to the field information provided by the stripper to provide synchronization of light shutters to control delivery of respective images to respective eyes of a viewer.

According to another aspect, apparatus for providing control signals to light shutters for operation to view stereoscopic images includes a first infrared light emitting source to provide coordination signals to a receiver associated with shutters, and a further infrared light emitting source to increase the area of coverage by infrared light to allow increase the area in which the stereoscopic images can be viewed.

According to another aspect, a stereoscopic viewing system for viewing stereoscopic images provided by a source includes a pair of light shutters to control delivery of respective left and right eye images for viewing as a stereoscopic image provided by an image source, a free running drive circuit for driving the respective light shutters, a control circuit responsive to a prescribed input for synchronizing operation of the light shutters, and a detector for detecting incoming coded signals representing a prescribed operation of the control circuit to operate the shutters for viewing a stereoscopic image.

According to another aspect, apparatus for detecting characteristics of computer images and controlling a display and light shutters for viewing of such images includes a detector for comparing signals representing two different colors and a reference to determine whether image signals are provided in stereoscopic pairs or planar, a display controller for controlling delivery of such image signals to a display in a format according to the detector response, and an output for selectively controlling light shutters for viewing stereoscopic images or planar images.

To the accomplishment of the foregoing and related ends, the invention, then, comprises the features hereinafter fully described and/or particularly pointed out in the claims. The following description and the annexed drawings set forth in detail certain illustrative embodiments of the invention. These embodiments are indicative, however, of but a few of the various ways in which the principles of the invention may be employed.

A number of features are described herein with respect to embodiments of the invention; it will be appreciated that features described with respect to a given embodiment also may be employed in connection with other embodiments.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

In the annexed drawings:

FIG. 1 is a system diagram of a 3D (stereoscopic) display system using a viewing system in accordance with the present invention;

FIG. 2 is a schematic illustration of a viewing system of the invention used in a computer-related environment with a wire connection to the shutter glasses;

FIG. 3 is a schematic illustration of a viewing system of the invention used in a computer-related environment with a wireless link or connection to the shutter glasses;

FIG. 4 is a schematic illustration of a viewing system of the invention used in a television environment with either a wire connection or a wireless link or connection to the shutter glasses;

FIG. 5A is a schematic electric circuit diagram of a transmitter circuit for use with a VESA compliant input circuit thereto for developing a wireless output to control operation of shutter glasses used in a viewing system of the invention;

FIG. 5B is a stereo sync signal timing diagram;

FIG. 5C is a computer program flow chart diagram showing the signal advance technique used in the invention to accommodate liquid crystal cell latency, switching time and transmission time;

FIG. 6 is a schematic illustration of shutter glasses responsive to a wireless input signal for sequentially opening and closing the respective left and right eye liquid crystal shutter lenses;

FIG. 7 is a schematic electric circuit diagram of a circuit to coordinate and to synchronize operation of shutter glasses in response to a VESA compliant input signal from a computer or the like;

FIG. 8A is a schematic electric circuit diagram of a circuit for coordinating and synchronizing operation of shutter glasses in response to an input from a television signal; and

FIG. 8B is a free-running circuit to operate shutter glasses in response to wireless, e.g., infrared, synchronization signals while avoiding conflict with conventional IR remote control equipment;

FIG. 9 is a schematic electric circuit diagram of a circuit responsive to video graphics adaptor (VGA) signals to develop control and synchronization output for operating shutter glasses for 3D viewing.

### DESCRIPTION

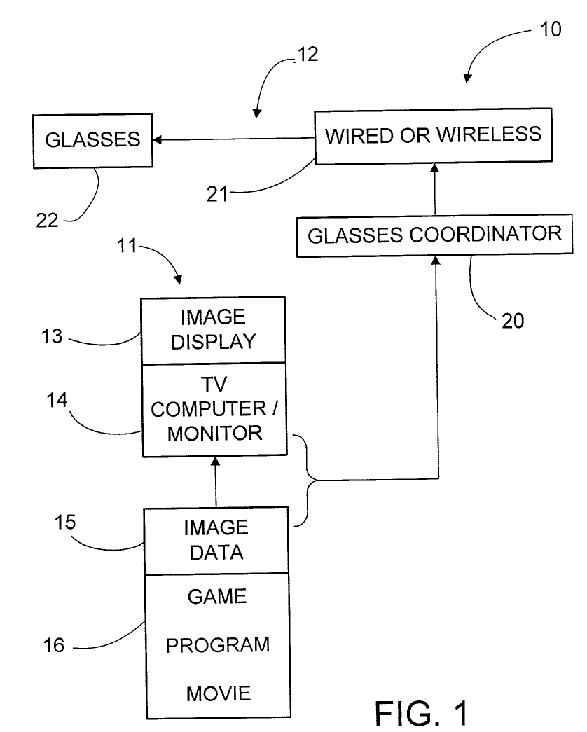

Referring in detail to the drawings, wherein like reference numerals designate like parts in the several figures, and initially to FIG. 1, a 3D display system is generally indicated at 10. The 3D display system 10 is for displaying images for stereoscopic viewing to allow user to perceive depth or three dimensions. The 3D display system 10 includes a display system 11 and a viewing system 12. The display system 11 includes a display device 13, such as a cathode ray tube (CRT), liquid crystal display, plasma display, or some other display which shows an image in response to appropriate input. The display system 11 also includes a display controller 14 which controls operation of the display device 13, such as by providing electrical signals to the display device causing it to display an image. The display controller may be, for example, television circuitry (for example, video circuitry), a computer (such as a personal computer or other computer), special game computer (such as those sold under the trademark SEGA or other trademarks), etc., or any other appropriate device able to operate the display device 13 to display images as desired. Additionally, the display system 11 includes a source of image data 15. The image data may be that received via a cable television connection and an antenna, a global network (Internet), wide area network (WAN), or large area network (LAN), etc. The image data may be in the form of a video signal for use to operate a television; it may be digital image data, such as that stored on and/or provided by a DVD, CD-rom, computer hard drive, cassette, tape, network, etc., able to be used by a computer, for example, to display appropriate images on the display device 13. Exemplary sources of image data are represented at 16, such as a video game or computer game, a computer program, a movie, etc.

The viewing system 12 includes a shutter glasses coordinator and synchronizing device 20, several types of which are described in greater detail below, a wired connection or wireless link connection 21, and shutter glasses 22. The shutter glasses 22 may be, for example, a pair of liquid crystal shutters mounted in a frame similar to an eyeglass frame which positions one liquid crystal shutter before (in front of) one eye and the other liquid crystal shutter before the other eye. The liquid crystal shutters typically include respective polarizers for cooperation with the liquid crystal cells, such as twisted nematic liquid crystal cells (or other suitable liquid crystal cells able to function in a shutter mode either alone or in association with other means, such as polarizers, for example) to allow for controlled selective operation to transmit light or to block light transmission. The wired connection 21 may be, for example, a wire connecting the coordinator 20 with the shutter glasses 22 or may be a wireless link connection, such as an infrared link, whereby the coordinator 20 causes an infrared signal to be transmitted to the shutter glasses 22 so an infrared receiver at the shutter glasses 22 receives that infrared signal and causes appropriate operation of the shutter glasses 22.

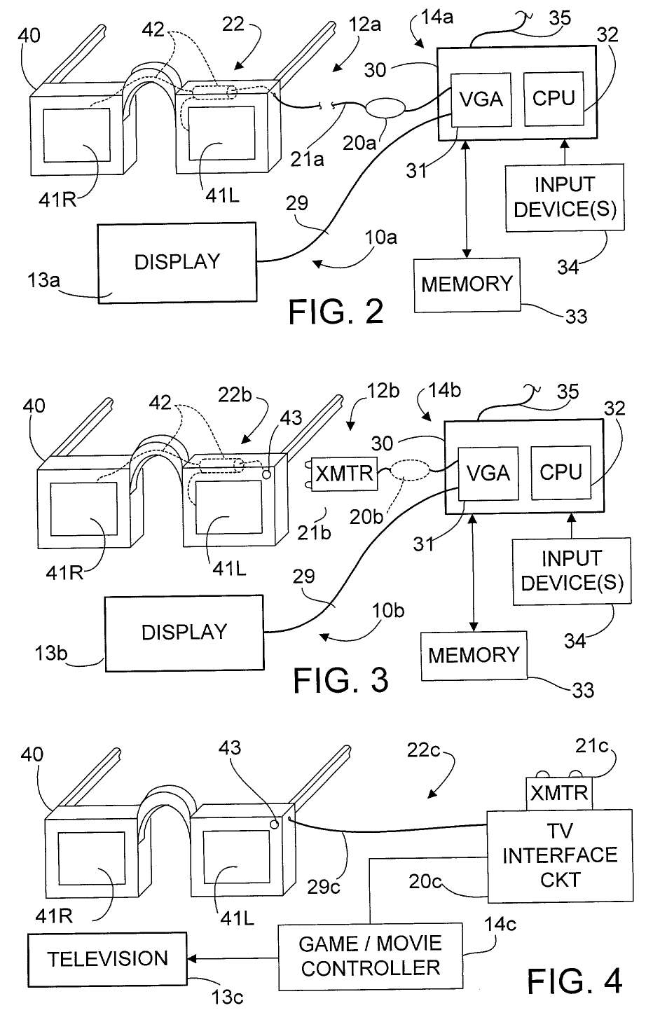

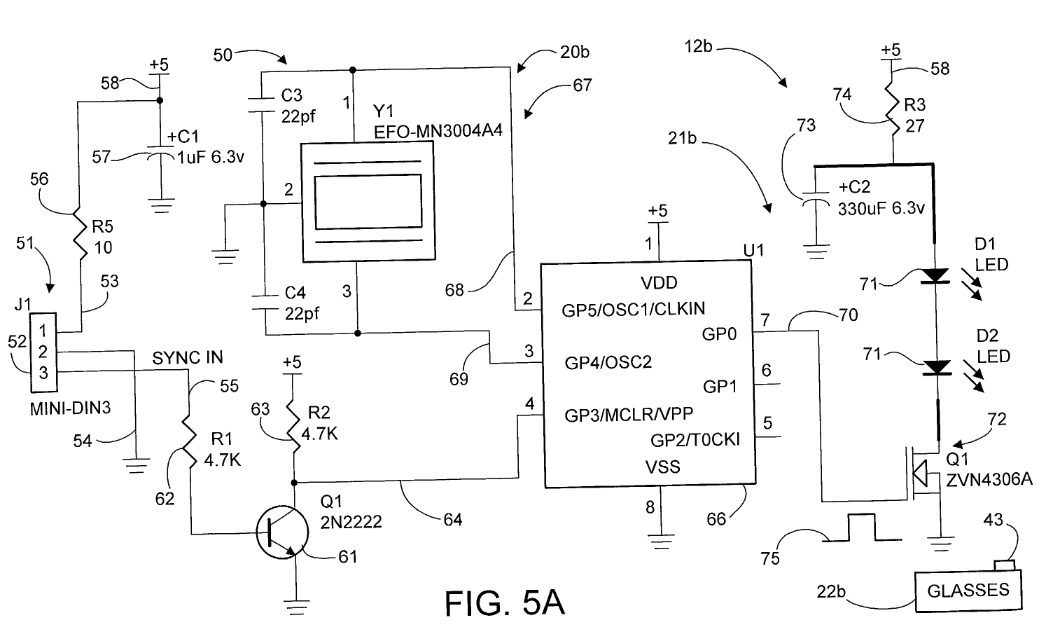

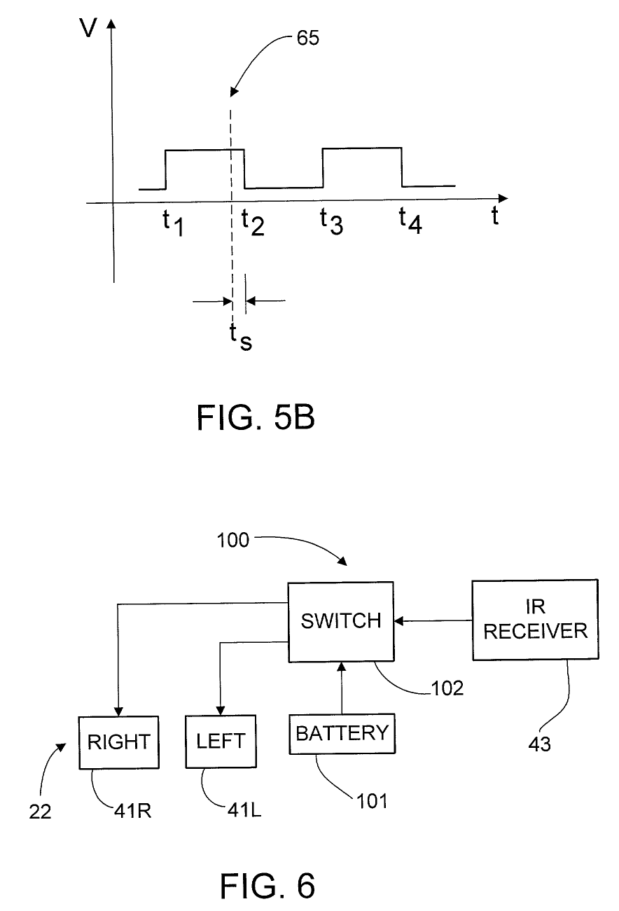

Referring to FIG. 2, an exemplary display system 10a is illustrated. In FIG. 2 suffix letters, such as the letter “a”, are used to designate parts that are similar to corresponding parts shown in FIG. 1 designated by the same reference number without the suffix. The elements in FIGS. 3 and 4 are similarly designated “b” and “c”. The display device 13a is a computer display or monitor, for example, a CRT, liquid crystal display, or some other type display. The display controller 14a provides signals on a line 29 to operate the display device 13a to show respective images. The display controller 14a is a video graphics adapter (VGA) card 30 and a computer 31. The computer 30 may be a personal computer or some other type of computer which includes a central processor unit (CPU) 32, a memory 33, such as a disk drive, DVD, CD rom, RAM, ROM, etc. One or more input devices 34 may be used to operate the computer 30, such as a key board, joy stick controller, etc. Additionally, a connection 35 may provide an interconnect for the computer 30 to a network, such as a global computer network, such as the Internet, a WAN, LAN, etc.

The viewing system 12a includes a coordinator device 20a and a wired connection 21a to shutter glasses 22a. The shutter glasses include a frame 40, respective liquid crystal shutters 41L, 41R, and electrical connections, leads, etc. 42 for providing electrical power to the respective liquid crystal shutters selectively to open and to close them for light transmission and light blocking functions, respectively.

Preferably the liquid crystal shutters 41L, 41R are driven by the drive circuitry operating them to a dark mode or light blocking mode to avoid leakage of a given left or right eye image to the wrong eye. The shutters usually respond faster to a driving voltage than they do to a removal of the driving voltage. The shutters may be allowed to relax to the relatively clear light transmitting state to transmit a given image to the correct eye, for as that image brightens, while the shutter clears, the image does not change and reaches the correct eye.

Turning briefly to FIG. 3, a display system 10b is illustrated. The display system 10b is similar to the display system 10a except the connection between the display controller 14b (computer 30) is a wireless link connection using an infrared transmitter 21b in place of the wire interconnect 21a. The transmitter 21b either has its own internal circuitry or is connected to a coordinator device 20b, which is shown in dotted outline, to provide the desired coordination and synchronization of operation of the shutters 41L, 41R of the shutter glasses 22b. The shutter glasses 22b include an infrared sensor 43, which detects infrared signals from the transmitter 21b. Circuitry 44 in the shutter glasses 22b responds to signals received by the sensor 43 and appropriately operate liquid crystal shutters 41L, 41R. Since the shutter glasses 22b are not connected by a wire to the coordinator device 20b or computer 30, the circuitry 44 ordinarily would include a battery or some other source of electrical power and a switching circuit selectively to deliver power to operate the shutters 41L, 41R, as is described in further detail below.

In both cases of the display systems 10a, 10b of FIGS. 2 and 3 the display controller 14a, 14b is a computer 30 and the display device 13a, 13b is a monitor or the like. In contrast, in FIG. 4 the display device 13c is a television or a television display tube, CRT, liquid crystal display, etc., and the display controller 14c is, for example, a television circuit, video game, a movie source, such as a DVD, VCR, connection to a network, etc. The coordinator 20c is an interface electrical circuit that responds to television type signals, for example, video signals, with appropriate information being provided to indicate whether images being displayed on the television 13c are stereo (3D) or planar (2D), and if stereo, what type of stereo. The coordinator television interface circuit 20c is coupled to the shutter glasses 22c, either via a wire connection 29 or by a wireless link connection using a transmitter 21c and receiver/detector 43. Circuitry in the shutter glasses 22c responds to the signals from the television interface circuit 20c to operate the liquid crystal shutters 41L, 41R in coordinated and synchronized relation to the respective left and right eye images displayed on the television 13c.

In operation of the several exemplary display systems 10, 10a, 10b and 10c and others embodying featuring of the invention, the television or computer typically operates the display to present respective left eye and right eye images for viewing by a user who would be wearing appropriate shutter glasses. As the computer or television causes the display to present sequentially left eye and right eye images, the left shutter 41L and right shutter 41R sequentially will be opened and closed. Accordingly, ordinarily it is intended that the user would be able to view the left eye image when it is presented on the display by using the left eye viewing light transmitted through the left shutter 41L while the right shutter 41R blocks light transmission; and vice versa for the right eye image.

The invention is described in further detail below with reference to several possible display systems. The display systems and the several embodiments of the invention, which are described in greater detail below, are depicted in the following Chart A.

CHART A

| | | | |
|---|---|---|---|
| | | | (Works field |
| | (Works in page | (Works in all | sequential |
| | flip mode only) | stereo modes) | only) |
| CHART A | | | |
| | Computer with | Computer w/o | |
| END | VESA Compliant | VESA Compliant | Television |
| APPLICATION | Output to system | Not a VESA | TV |
| | is VESA spec | spec output | |
| WIRELESS | I. Items: 1 + 4 | III. Items: | V. Items: 3 + 4 |
| VIEWING | | 2 + 1 + 4 | |
| WIRED | II. Item: 6 | IV. Items: 2 + 5 | VI. Items: |
| | | | 3 + 5 |
| VIEWING | | Could upgrade to | Could upgrade |
| | | 2 + 1 + 4 | to 1 + 4 |
| | | | for improved |
| | | | (group) |
| | | | coverage |
| APPARATUS | 1 = Transmitter; | 2 = VGA | 3 = TV |
| | could be smart | Dongle | Dongle |
| | transmitter to do | | |
| | what dongle does | | |
| | or could be | | |
| | dumb & requires | | |
| | dongle. | | |
| | 4 = Wireless | 5 = Dumb wired | 6 = Smart |
| | glasses | glasses | wired glasses |

A summary of Chart A is presented here. Details of the several embodiments represented in Chart A are described in detail below with respect to other drawing figures hereof. The invention is described below for use with displays that either are operated by a computer or computer type of system, as via a VGA card or the like; or displays that are television type displays. In the case of television type displays consideration is given in the wireless viewing embodiment to avoiding conflict with conventional remote control systems associated with televisions, such as, for example, remote control devices to change channels, adjust volume, etc. of a television or cable box, remote control devices that operate VCR systems, DVD systems, and the like. Those remote control systems typically used with televisions often use infrared signals that produce a relatively long duration infrared pulse, say on the order of many milliseconds, sometimes on the order of several hundred milliseconds. The wireless embodiment of the invention used in conjunction with television systems avoids conflict with such other conventional remote control systems. In the computer driven display embodiment with which the invention may be used, there are two sub-categories of embodiments described in greater detail below; one is a computer system having a VESA (Video Electronics Standards Association) compliant output system, and the other is a computer system without a VESA compliant output system. In a VESA compliant output system, signals produced by the computer include a power signal, a ground signal, and a stereo sync (synchronization) signal; these may be provided by the VGA card of the computer. In a computer system that does not have a VESA compliant output, embodiments of the invention are described below using the VGA output signals produced by a conventional VGA card of a computer. The several examples of the invention described in greater detail below and mentioned in Chart A are examples of uses of the invention in various display systems; it will be appreciated that features of the invention as described in embodiments for one display system may be used by another that is described herein or that currently may exist or may be developed in the future.

Page Flip Stereo Mode:

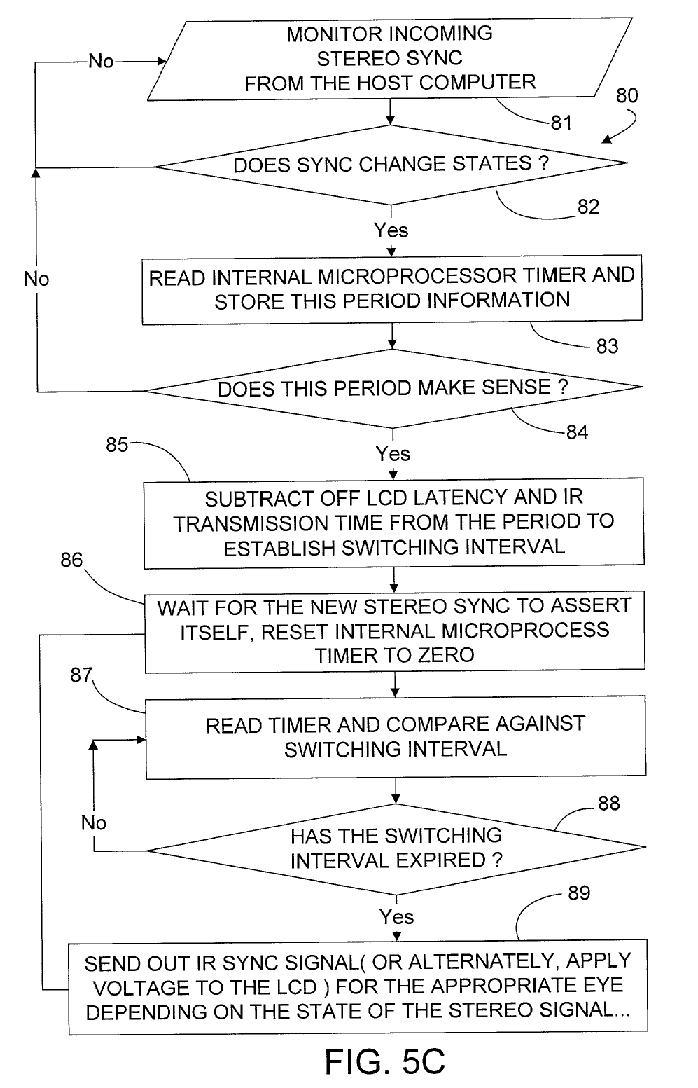

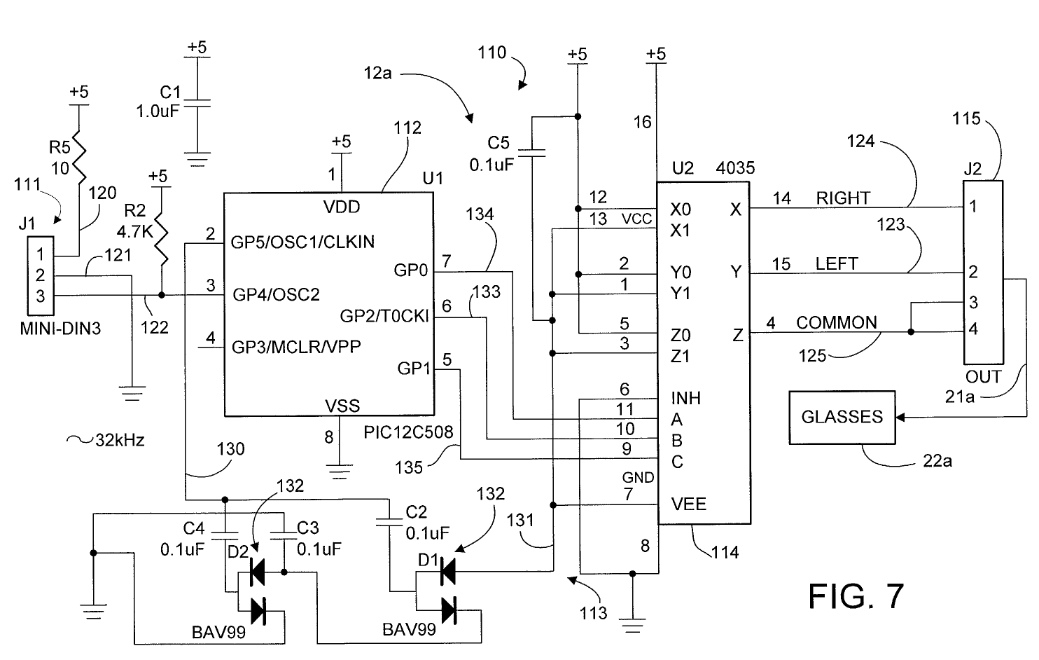

Referring to FIGS. 5, 5A, 5B and 6, a viewing system 12b is illustrated. The viewing system 12b is for use with a computer driven display system, such as that shown at 10b in FIG. 3 in which the output from the computer 14b is VESA compliant, i.e., the output conforms to the VESA specification for use in 3D stereoscopic viewing systems. The viewing system 12b is a wireless system in that an infrared link is used to coordinate and synchronize operation of the shutter glasses 22b seen both in FIGS. 5 and 6; such a system is identified in Chart A at item I (the upper left block).

Note that items I and II in Chart A depict stereo viewing apparatus and operation in page flip mode. There is no need to detect that the display system 10 is operating in 3D stereo mode, as such is assumed in page flip mode. If such were required, the detection could be carried out in the computer 30 and programing associated with the computer and the VGA card 31 thereof. Such programming may be along the lines of that described with respect to FIG. 5C.

As shown in FIG. 5A, a combination glasses coordinator circuit 20b and transmitter circuit 21b are combined as a single circuit. If desired, though, the two may be separate, but are connected as by a wire or other conductor 70. The combined circuit of FIG. 5A is designated by reference numeral 50. The input 51 to the circuit 50 is provided via an electrical connector 52, sometimes referred to as an VESA connector, which receives from the VESA compliant output, such as from a VGA card, of the computer 30 a power signal on line 53, a ground signal on line 54, and a sync signal on line 55. The power signal on line 53 is filtered by a resistor 56 and capacitor 57 to provide a five volt power level at 58 used elsewhere in the viewing system 12b. The sync signal on line 55 is coupled by a transistor circuit 60, which includes a transistor 61 and resistors 62, 63. The transistor circuit 60 “crisps up” the sync signal making it relatively accurately defined with relatively sharp transitions to provide on line 64 a square wave signal, such as that shown at 65 in the graph/timing circuit of FIG. 5A. The crisp square wave signal 65 on line 64 is coupled to an input of a micro controller 66. The micro controller may be, for example, model PIC 12C508 made by Microchip Technology Inc. Two other inputs to the micro controller 66 are provided by an oscillator 67. The oscillator 67 is, for example, a ceramic resonator type oscillator which provides on lines 68, 69 output pulses that are relatively strictly controlled with minimal drift thereby providing accurate timing for operation of the micro controller 66. The output on line 70 from the micro controller 66 is coupled to the wireless link circuit 21b. More particularly, the wireless link circuit 21b includes one or more light emitting diodes (LED) 71, which emit output in the infrared spectrum range, and a MOSFET switch 72. Power for the wireless link circuit 21b is supplied by a connection from the five volt power supply connection to the power signal 58, which is used to charge a capacitor 73 via an isolating resistor 74. In an embodiment of the invention upon closing of the transistor switch 72 in response to a square wave pulse 75 on line 70 from the micro controller 66, the capacitor 73 discharges through the LED's 71 causing an infrared output therefrom. The (IR) infrared output may last for a relatively short time, for example, on the order of about 60 microseconds. The charge stored in the capacitor 73 is sufficient to operate the LED's to produce the (IR) infrared output for a suitable time at suitable intensity without the LED's drawing power directly from the VESA connector 51. As a example, the output current may be on the order of approximately one amp. Since the duty cycle is rather small, on the order of, for example, 60 microseconds, the actual power dissipation is relatively small each time the capacitor 73 is discharged. The capacitor 73 is re-charged between discharge operations.

The micro controller 66 is a programable device, and an example of a computer program flow chart or flow diagram for use therein is represented at 80 in FIG. 5C. The coordinator circuit 20b operates to cause periodic pulsing of the LED's 71 to cause sequential opening and closing of the lenses 41L, 41R in the shutter glasses 22b in coordinated relation with the image being displayed on the display 13b, for example, and synchronized with respect thereto. Such coordination and synchronization is provided in response to the sync signal received on line 55. Such sync signal is the stereo sync signal from the computer 30 and/or the VGA card 31 thereof. In an embodiment of the invention, the coordinator circuit 20b provides a delay function to accommodate latency and switching time of the liquid crystal cells 41L, 41R and possibly delays in signal development and/or transmission in the viewing system 12. Latency is the delay in the start of switching from one state to another after an appropriate signal is delivered to the liquid crystal cell. Switching time is the time required for the liquid crystal to switch from one mode to the other after switching has commenced. These are known characteristics and parameters of conventional twisted nematic liquid crystal cells.

The objective of the computer program or flow chart depicted in FIG. 5C and 81 is to determine the period between valid stereo sync signals received at the sync input on line 55 in the circuit 20b of FIG. 5A. Then an amount of time is in a sense subtracted from those stereo sync signals to determine a point in time prior to the occurrence of those stereo sync signals that the liquid crystal cells 41L, 41R respectively are to be operated to account for latency and switching time. Looking at FIG. 5B, for example, at times t₁-t₄ respective changes or transitions in the stereo sync signal 65 occur.

Summarizing operation of the computer program 80 stored in the microcontroller 66, the program determines the period of time between transitions, e.g., between t₁ and t₂ of the stereo sync signal 65. The program 80 then subtracts from each transition time a period of time tₛ, such as that shown at t₂. It is at the point in time of t₂ minus tₛ that the switch 72 is turned on to discharge the capacitor 73 causing the emitting of an infrared signal by the LED's 71. The amount of time tₛ that the turning on of the switch 72 occurs prior to occurrence of stereo sync transitions at times t₂, for example, is approximately adequate to account for latency and switching time of respective liquid crystal cells in the shutter glasses 22 and possibly also to account for transmission delays. In a sense the subtracting of the time tₛ from the stereo sync transition time is analogous to the advancing of the spark in the gasoline engine of an automobile.

Turning more specifically to the computer program flow chart 80 of FIG. 5C, at step 81 the incoming stereo sync signals 65 occurring on line 55 coming from the computer 30 (or the VGA card 31 thereof) are monitored. At step 82 an inquiry is made whether the stereo sync signal has changed state, e.g., transitioned from one logic level to another such as those transitions occurring at times t₁, t₂, t₃, and t₄ as shown in FIG. 5B. If not, then monitoring continues at step 81. When the stereo sync signal changes state (transitions) as detected at step 82, the internal timer in the microcontroller 66 is read and stored; and the time between such transition and the prior one is computed to determine the period (of time) between respective transitions, such as transitions t₁ and t₂ shown in FIG. 5B. At step 84 an inquiry is made to determine whether the period information makes sense. For example, if a noise signal were to occur or if there were some instability at start up, unanticipated stereo sync pulses or transitions may occur; if they are too close together, for example, or perhaps, too far apart, then the period would not make sense. The period may be set in the microcontroller 66, for example, according to the anticipated approximate time of the period between respective sequentially occurring stereo sync transitions. An example of such a time period may be on the order of 16 milliseconds, 32 milliseconds, etc., depending on the refresh rate or occurrence of stereo sync pulses in the display system 10. If the period does not make sense then the program flows back to step 81 until the period does make sense at step 84.

At step 85 a specified amount of time is subtracted from the anticipated transition time of the stereo sync signal. Looking at FIG. 5B the first transition occurs at time t₁, the next transition occurs at time t₂. The subtracted time period is indicated as the time between time tₛ and time t₂ and shown in FIG. 5B. The amount of time that is subtracted is in effect the advance of the infrared signal to send such signal earlier than needed. In an exemplary embodiment the amount of time subtracted from the transition time t₂ may be, for example, from several microseconds to several hundred microseconds, although these values are not intended to be limiting. The subtraction occurs prior to each transition of the stereo sync signal thereby to assure that as the liquid crystal cells sequentially are turned to light transmitting or light blocking modes, those modes occur and the respective liquid crystal cells are ready to transmit light (or to block light) when the respective left or right eye image is shown by the display.

At step 86 the program waits for the new stereo sync to assert itself; at which point the internal timers in the microcontroller 66 are reset to 0. At step 87 the timer in the microcontroller 66 is read and compared against the anticipated switching interval, i.e., when the next stereo sync transition is expected to occur. At step 88 an inquiry is made whether the switching interval has expired. If not, then a loop is followed back to step 87. If the switching interval has expired, then at step 89 the infrared signal is transmitted; for example, the microcontroller 66 turns on the transistor switch 72 to cause emitting of light by the LED's 71. Thereafter, loop line 90 is followed so that the infrared pulses are transmitted sequentially based on the sequentially occurring stereo sync transitions minus the specified time period that is subtracted from each as was mentioned above with respect to step 85. If necessary at step 89 the microcontroller 66 keeps track of which eye is being switched, i.e., the left eye or right eye, so the appropriate eye shutter is transmissive or blocking light. Alternatively or additionally, if the viewing system is a direct wired system to the shutter glasses, then rather than or in addition to the (IR) infrared signal transmission, the appropriate voltages are sequentially applied to the respective shutters.

Briefly referring to FIG. 6, a schematic illustration of shutter glasses 22b is illustrated. In the shutter glasses 22 there are two liquid crystal shutter lenses 41L, 41R, which are selectively driven to light transmitting or light blocking states by a circuit 100. The circuit 100 includes a battery or some other power supply 101, a switch 102 for selectively coupling the power from the battery 101 to the respective liquid crystal shutters, and an infrared receiver/detector 43. In operation of the shutter glasses 22, respective infrared pulses are received by the infrared receiver 43 from, for example, the LED's 71 (FIG. 5A). In response to receiving such signals, the (IR) infrared receiver 43 operates the switch 102 alternately to deliver power from the battery 101 to the respective liquid crystal shutters 41L, 41R so that one is in the light transmitting mode while the other is in the light blocking mode, and vise versa.

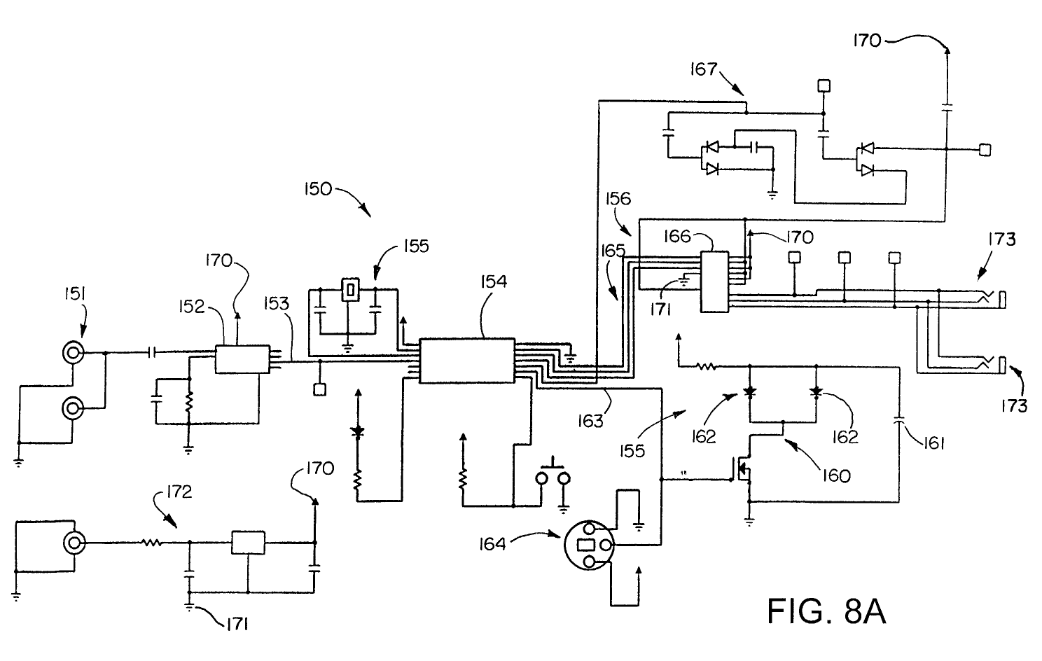

Turning, now, to FIG. 7, a circuit 110 for a display system 12a (FIG. 2) is illustrated. The circuit 110 is useful in connection with item II in Chart A where a wired viewing connection is provided between glasses 22a and a computer 14a with a VESA compliant output. The circuit 110 (sometimes referred to as a “dongle”) includes an input connector 111, a microcontroller 112, a voltage doubler circuit 113, a multiplexer/demultiplexer 114, and an output connector 115, which is coupled to the glasses 22a by a wire connection 21a. In use the circuit 110 receives at the input connector 111 a power signal on line 120, a ground connection on line 121, and the stereo sync signal 122, all from the computer 30 or the VGA card 31 thereof. In response to those signals and programing in the microcontroller 112, such as the program described above with respect to the flow Chart 80 of FIG. 5C, the multiplexer 114 is controlled to deliver power sequentially to the left and right liquid crystal shutters in the glasses 22a via respective left and right output lines 123, 124 and a common line 125. The microcontroller may be a model PIC12C508 of Microchip, and the multiplexer 114 may be a model 4053.

The voltage doubler 113 is a negative voltage doubler. It receives an input voltage on line 130 at a frequency determined by the microcontroller 112, for example, on the order of 32 Khz and provides on line 131 an output of minus ten volts less various diode drops of the diodes 132 in the voltage doubler circuit.

The microcontroller 112 receives the stereo sync pulses or signals on line 122. In the circuit 110, the microcontroller receives the stereo sync pulses directly without the need for the “sharping or crisping” function provided by the transistor 61 in the circuit 50 of FIG. 5A, and the microcontroller uses its own internal oscillator for clock or timing function rather than requiring a separate oscillator 67 shown in the circuit 50 of FIG. 5A. Since the circuit 110 is directly connected by wire to the glasses 22a, the circuit 110 is more tolerant of a slight mis-timing or slight signal drift as compared to the circuit 50 of FIG. 5A which is used for wireless connection. In a wireless connection circuit, there is greater possibility of a miscommunication between the transmitter and receiver if there is a mis-timing or signal drift occurrence. Moreover in the circuit of FIG. 5A, the (IR) infrared pulses are produced for short durations and they cause triggering functions in the glasses 22b to switch the liquid crystal shutters, whereas in the direct wired circuit 110 of FIG. 7, the microcontroller 112 causes switching operation of the multiplexer/demultiplexer 114 which delivers signals on lines 123-125 directly to the glasses 22a to cause the liquid crystal shutters to be in respective light transmitting or light blocking modes without having to rely on the synchronization and coordination function provided via brief pulses transmitted over a wireless link.

The microcontroller 112 is programed to produce on line 130 a square wave signal of, for example, 32 KHz. The voltage doubler circuit 113 then provides on line 131 a DC voltage on the order of minus 10 volts, which is supplied as an input to the multiplexer/demultiplexer circuit 114. Respective outputs from the microcontroller provided on lines 133, 134, and 135 cause switching in the multiplexer/demultiplexer 114 to deliver on output lines 123, 124, 125 thereof respective signals to operate the liquid crystal shutters 41L, 41R in the shutter glasses 22a.

The signals on output lines 123, 124, 125 from the multiplexer/demultiplexer 114 drive the liquid crystal shutters in conventional manner to avoid polarizing the respective liquid crystal cells. For example, the voltages applied to the liquid crystal cells are plus 5 volts and minus 10 volts. In the clear or light transmitting state for a given liquid crystal shutter, the common line 125 connected thereto is at the same electric potential as the drive line thereto. However, for the dark state or non-light transmitting state, the common line is at the opposite potential as the other line 123 or line 124 connected to the liquid crystal shutter. If desired the potential across the liquid crystal cell can be changed to +15V, or −15V to turn it dark; and 0V to keep it light. The net DC voltage is 0 volts and avoids polarization of the liquid crystal cell. An exemplary Chart B below represents exemplary possible voltage combinations to operate the respective shutters, as follows:

CHART B

| Lines | Dark (light blocking) | Light (transmitting) |
|---|---|---|
| 124, 125 | +5, −10 or −10, +5 | +5, +5 or −10, −10 |
| 123, 125 | +5, −10 or −10, +5 | +5, +5 or −10, −10 |

The microcontroller 112 also is programed to advance the signals to the liquid crystal shutters in a manner similar to that described above with respect to FIG. 5A to accommodate latency and switching time of the liquid crystal shutters.

Since the circuit 110 is directly connected by the wire 21a to the shutter glasses 22a, the circuit 110 may be directly connected in the wire between the computer 14a and the shutter glasses 22a as is illustrated, for example, at 20a in FIG. 2. The circuit 110 may be contained in a suitable housing that is molded directly to the cable 21a or may be in a housing that is clamped together and to the cable, as a clam shell arrangement, holding the cable and circuit 110 in relative position to each other while preferably also providing suitable strain relief to avoid pulling connections apart. Alternatively, the circuit 110 may be mounted in a separate housing that is plugged into the VGA card 31; and the cable 21a then is connected between the output connector 115 and the shutter glasses 22a.

Summarizing the first column of Chart A, Item I and Item II are for use with a computer having a VESA compliant output. Item I is for wireless viewing using a wireless link transmitter; the transmitter may be a “smart” transmitter which includes the various signal advancing functions described above and also includes a circuit to energize the LED's. Item II in Chart A requires smart wired glasses only. In such case the smart glasses drive circuit 110 illustrated in FIG. 7 may be used.

In Chart A features of the invention for use with a television are represented at items III and IV. Item III provides wireless viewing and item IV provides wired viewing. Both of these viewing systems 22c are represented in FIG. 4, which shows two possibilities of connection between the TV interface circuit 20c, either via a wireless link provided by a transmitter 21c in the interface circuit and a receiver 43c at the shutter glasses or via a cable connection 29c provided between the interface circuit 20c and the shutter glasses 22c.

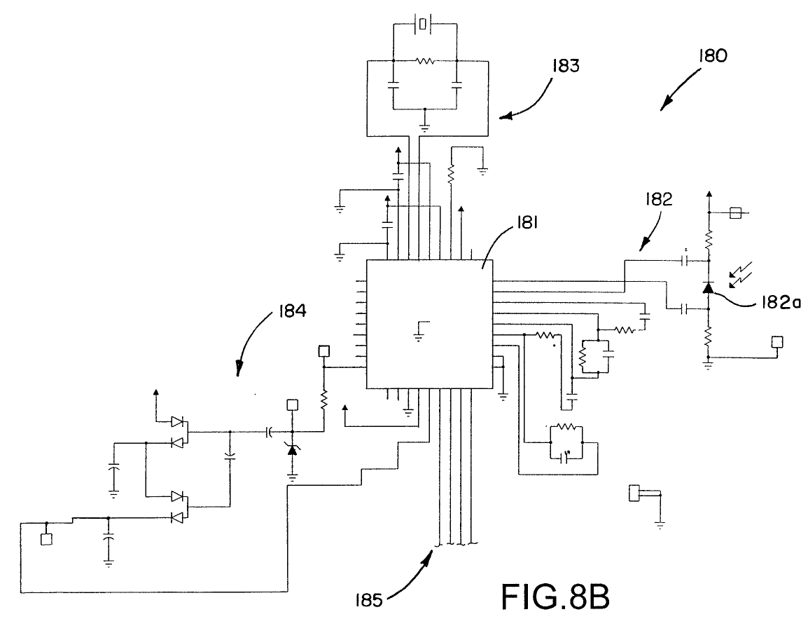

In item III of Chart A for wireless viewing, a circuit 150 shown in FIG. 8A may be used to derive from video input signals infrared pulses (or some other wireless signal) which may be received by the wireless shutter glasses 22c to coordinate and synchronize operation of the liquid crystal shutters thereof. Such glasses include a free running switching circuit that alternately turns the liquid crystal shutters to light transmitting and light blocking modes in coordination and synchronization with the infrared drive signals. For the direct wired embodiment using the cable 29c the shutter glasses maybe plugged in directly to the circuit 150 to receive the driving power to operate the liquid crystal shutters to light transmitting and light blocking modes.

Field Sequential Stereo Mode:

In FIG. 8A the circuit 150 includes a video input connector 151 able to receive either NTSC or PAL format video signals. If other video signals are developed in the future, these also may be accommodated by appropriate adjustment as will be evident to those having ordinary skill in the art. The video input signal is provided to an integrated circuit (IC) 152, such as an Elantec 1881. The IC 152 operates as a standard sync stripper. It strips out the field information from the video signal and provides that field signal on line 153. Typical video signals are provided in sequential frames, and each frame has two fields. In an embodiment of the invention the left eye image will be displayed in field 0 and the right eye image will be displayed in field 1. The IC 152 provides the field information to the microcontroller 154 via line 153. The signal on line 153 is coordinated to the particular field being displayed at a given time.

The signal on line 153, then, is a representation of whether field 0 or field 1 is being displayed. The signal on line 153 is provided to a microcontroller 154, such as a Microchip model PIC12C508 described above. A ceramic oscillator 155 also provides an input to the microcontroller 154. The microcontroller 154 provides output driving signals to one or both of an infrared transmitter circuit 155 and a wired connection circuit 156. The (IR) infrared transmitter circuit 155 includes a MOSFET switching transistor 160 which, when turned on, discharges a capacitor 161 through light emitting diodes (LED's) 162 which emit infrared radiation for detection by the detector 43 (FIG. 4).

In driving (IR) infrared transmitter circuit 155 the microcontroller 154 provides on line 163 signals that are timed to cause production of infrared pulses by the LED's 162 so as to be detected by and cause coordinated and synchronized operation of the shutter glasses 22c, on the one hand, while avoiding interfering with other standard remote control devices that use infrared transmission and detection. More particularly, the signals produced online 163 have the “spark advance” feature described above with respect to FIG. 5C so that such signals occur slightly before any image change on the television 13c, thereby to accommodate latency, switching time and transmission time, as were described above. Also the signals on line 163 are of significantly short duration and at sufficiently large spaced apart intervals so that conventional infrared detector remote control devices will not respond to the infrared signal outputs from the LED's 162. For example, the LED's 162 may be operated to produce pulses on the order of 60 microseconds in duration, each signal occurring such that approximately three pulses or signals are spread out over a 500 millisecond period. In contrast, a typical signal for a conventional remote control device may last milliseconds, even several hundred millisecond. Thus, the duty cycle of the infrared signal produced by the LED's 162 is substantially lower than that of a conventional infrared remote control system, and, therefore, will not affect such a system.

The circuit 150 also includes an additional output jack 164 which may be coupled to an additional transmitter to provide wider field of view or coverage by the wireless link signal, e.g., the (IR) infrared, for wider dissemination over an area for coordinating and synchronizing shutter glasses 22c used by multiple individuals viewing the television 13c.

The microcontroller 154 also delivers an output on lines 165 to the wired connect circuit 156. The circuit 156 includes a multiplexer/demultiplexer circuit 166, such as a Microchip CD40538C or some other multiplexer/demultiplexer. The circuit 166 also is connected to a voltage doubler circuit 167 (similar to the voltage doubler circuit 132 described above with respect to FIG. 7). The multiplexer/demultiplexer 166 thus receives voltage inputs of minus 10 volts from the voltage doubler 167 and plus 5 volts supplied at a power input connection 170. A ground also is provided at 171. The power and ground signals at terminals 170, 171 are provided by a conventional regulated power supply circuit 172. In response to signals on lines 165 from the microcontroller 154, the multiplexer/demultiplexer 166 provides plus 5 volts, to drive the liquid crystal shutters in the glasses 22c by direct wire connection to connectors 173, which in turn are coupled to the multiplexer/demultiplexer 166. Two connectors 173 are shown to allow for two sets of shutter glasses 22c to be plugged into the circuit 150; if desired additional shutter glasses may be provided.

It will be appreciated that in operation of the circuit 150 in a wire connect mode, the circuit 150 directly provides the driving signals to operate shutter glasses 22c, which simply provide for wire connections from the connectors 173 to the respective liquid shutters 41L, 41R. Additionally or alternatively, the circuit 150 may be used in a wireless mode whereby the LED's 162 periodically transmit (IR) infrared signals which are detected by a detector 43 in wireless shutter glasses 22c. The shutter glasses 22c in such case include circuitry for selectively opening and closing the liquid crystal shutters. Such circuitry includes a battery and /or other power supply which is selectively coupled to liquid crystal shutters to operate them to light transmitting and light blocking modes. Such circuitry may run substantially freely and periodically be synchronously coordinated with the (IR) infrared signals produced by the LED's 162. An example of such a circuit is illustrated in FIG. 8B.

The circuit 180 illustrated in FIG. 8B is able to send signals to the respective liquid crystal shutters 41L, 41R to operate them to light transmitting and light blocking modes. The circuit 180 that may be built directly into the frame of the shutter glasses 22c. The circuit 180 includes an application specific integrated circuit (ASIC) 181 which responds to and coordinates operation of and responds to several components included in the circuit 180. The circuit 180 includes an (IR) infrared receiver and amplifier circuit 182 which receives an (IR) infrared signal at a diode detector 182a, amplifies that signal and provides it to the ASIC 181. The circuit 180 includes a crystal oscillator 183, a voltage tripler 184, and output lines 185 to provide voltages to the liquid crystal shutters 41L, 41R to operate them, for example, in a manner similar to that described with respect to Chart B above. A suitable power supply, such as a battery, is associated with the circuit 180 to supply operating power to the circuit 180 and to provide suitable power for the circuit 180 to operate the liquid crystal shutters 41L, 41R. The circuit 180 and the power supply may be mounted in the shutter glasses.

In operation of the circuit 180, when the ASIC 181 detects a correct sequence of pulses having been received by the (IR) infrared detector 182, for example, representing that signals from a television system are being received, e.g., as in FIG. 4, the ASIC determines that operation of the liquid crystal shutters 41L, 41R is to be according to that required for a television system showing 3D images. The ASIC 181 then looks to the oscillator 183 which provides clock pulses that are counted in an internal timer in the ASIC; and the ASIC then delivers voltage from the voltage tripler 184 to the respective liquid crystal shutters via the output lines 185. Exemplary operation in such case may be to turn transparent the left shutter and light blocking the right shutter for 16 ms; then reverse that operation for the next 16 ms; etc., until the ASIC detects the next series of (IR) infrared signal pulses received by the detector 182a. At that point the ASIC resets its counter to zero or to some other specified value to resynchronize operation until the next series of (IR) infrared signal pulses is received by the detector 182a. The (IR) infrared pulses may be, for example, a series of seven (7) pulses to form a word that tells the ASIC how to operate the liquid crystal shutters. If the series of pulses is not received within a prescribed time frame, then the ASIC will shut down operation of the circuit 180. A switch, such as a manual switch (not shown) may be operated to restart the circuit 180 at a future time.

The sequence of seven pulses may be, for example, to close the left shutter, to close the right shutter, to open both shutters (e.g., stop “shuttering” the image because stereo no longer is being transmitted or because the television has turned off, etc.), operate in accordance with television NTSC timing, or operate in accordance with television PAL timing. The signaling by the seven pulses occurs for one or several short durations that occur over a relatively long time frame. For example, each pulse may be on the order of 15 microseconds wide in a period of 30 microseconds; therefore, the total period to obtain the seven pulses may be on the order of 210 microseconds. This total period is much shorter than a typical (IR) infrared signal used in conventional (IR) infrared remote control equipment, which may be, for example, on the order of about 500 milliseconds. The signal bursts of seven pulses occur from time to time to assure that they are received by the ASIC before the ASIC times out. Such time out period may be on the order of 700 milliseconds; therefore, an exemplary time between the occurrence of respective sequences of the seven pulses may be on the order of about 500 milliseconds.

Thus, it will be appreciated that the shutter glasses using a circuit 180 or similar circuit may operate on a continuous bases, provided appropriate pulses are provided thereto to tell the ASIC the type of operation and to resync the circuit 180 with the images being shown on the television. The features of the circuit 180 may be used in other embodiments of the invention described herein.

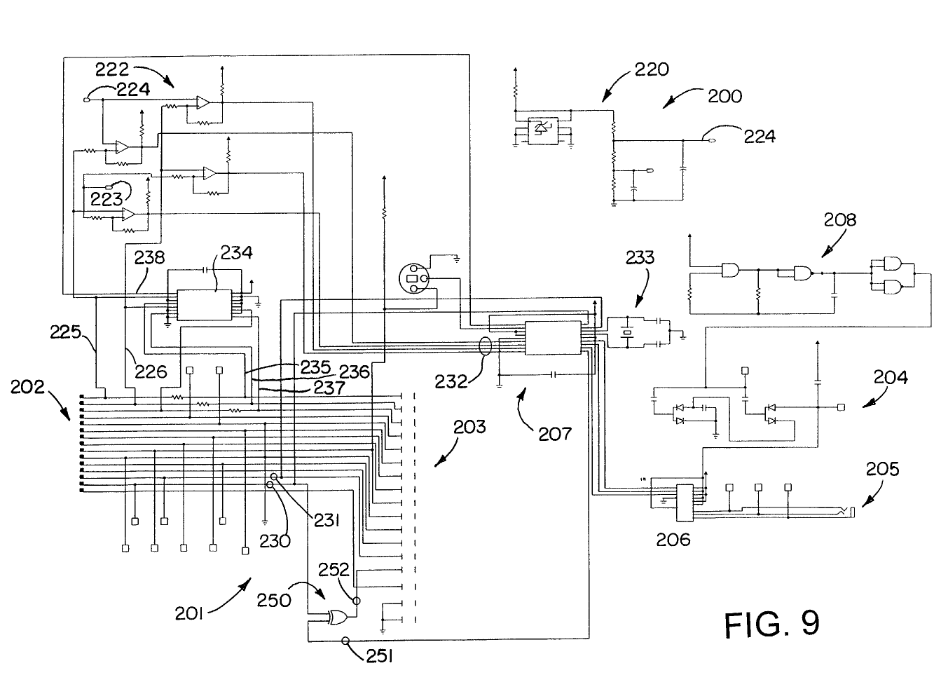

Referring to FIG. 9, a VGA compatible circuit 200 is shown. The circuit 200 is for use with a computer output from a VGA card or some other source associated with a computer or some other electronic device which is not a VESA specification output. The circuit 200 is referred to in Chart A as the VGA dongle and, accordingly, may be used with items III and IV in Chart A. Since circuit 200 is for use with a computer, concerns for interfering with other remote control devices are not considered in this circuit as they were in the circuit of FIG. 8A. The circuit 200 is able to use the outputs from a VGA card and based on those outputs to provide either wireless signaling to wireless shutter glasses such as those shown at 22b in FIG. 3; and the circuit 200 also may be used to provide a direct wire-connected drive to shutter glasses. The circuit 200 is operable to detect whether the input from the VGA card 31 of a computer 14b, for example, is providing two dimensional imaging or three dimensional imaging (stereoscopic). Also, the circuit 200 is able to detect from a received stereo signal the type of stereo or 3D mode, e.g., page flip, above and below, or interleaved.

The circuit 200 includes a VGA input/output/pass-through circuit 201 which receives the VGA signals from the VGA card at the input 202 and passes those signals to an output 203, which may be coupled to a computer monitor or display, such as that illustrated at 13a or 13b in FIGS. 2 and 3. The signals at the VGA output 203 are used to drive the display. Some of the VGA signals are intercepted for use in other portions of the circuit 200. For example, the vertical sync signal (VSYNC) is intercepted and an additional VSYNC signal is supplied in its place, as will be described further below. The horizontal sync signal, red signal and green signal are parasited and used elsewhere in the circuit 200 for use to identify when the circuit is to operate in a stereo mode (3D) or planar mode (2D) and what type of stereo mode.

At its output the circuit 200 includes a voltage doubler circuit 204, such as one of the voltage doubler circuits described above, to provide minus 10 volts and plus 5 volts outputs either directly to a wire connection to shutter glasses 22 or via a transmitter to receiver in wireless shutter glasses 22. An output connector 205 is provided to receive the appropriate signals for driving the liquid crystal shutters of such glasses in a manner described above. Moreover, a multiplexer/demultiplexer circuit 206 responsive to input signals from a microcontroller 207 delivers the respective drive signals to the liquid crystal shutters 41L, 41R via the connector 205, for example. A logic type oscillator circuit 208 provides an AC output signal, for example of 32 Khz, as an input to the voltage doubler 204. The oscillator 208 is able to convert a digital signal to an AC signal so that the voltage doubler 204 can be driven appropriately in order to provide the desired voltage output levels.

A voltage reference diode circuit 220 determines slicing levels to enable detection of when the red VGA signal is on, when it is off, and when the green VGA signal is on or off. By determining such slicing levels, then, the circuit 200 is able to compare those signals with the red and green VGA outputs. Such comparison leads to a determination what is the color pattern being delivered to the VGA pass through circuit 201 for use to detect whether stereo mode is to be turned on or off and for use to determine which type of stereo mode is called for. Such determination will described further below.

An analog to digital converter circuit 222 is a comparator which compares the signals on the output lines 223, 224 of the voltage reference diode circuit 220 with the red and green signals on the red and green input lines of the VGA pass through circuit 201. Accordingly, the red line 225 and green line 226 are coupled to the analog to digital signal convertor/comparator circuit 222 as illustrated.

The microcontroller 207 receives the vertical sync signal on line 230 and the horizontal sync signal on line 231. In response to such signals, and also in response to the values of the red and green VGA signals on lines 225, 226 as converted to digital representations and provided on respective lines 232 to the microcontroller 207 to represent whether red and green each is on or off, the microcontroller 207 is able to detect whether or not the display system 10 is operating in stereo mode and, if in stereo mode, which type. For example, the combination of red, green and yellow in the first three lines of a frame is detected by the comparator circuit 222 and the microcontroller 207 and the software associated therewith to identify whether the display system 10 is starting operation in a stereo mode (and which type of stereo mode), or is terminating operation in stereo mode and beginning operation in 2D mode. Software drivers operating in the computer 30 provide such information that can be detected and decoded by the circuit 200.

The microcontroller 207 receives a clock input from a 20 MHZ crystal oscillator 233. The relatively high frequency clock signal or timing signal provides for relatively tight timing constraints to facilitate finding the red and green signals, in particular, in microsecond time frames for high accuracy of operation of the circuit 200.

Page Flip Stereo Mode:

If the microcontroller 207 detects operation in a page flip stereo mode where one field of a frame is left eye image and the next field is right eye image, then the microcontroller operates the multiplexer/demultiplexer circuit 206 to produce respective coordinated and synchronized output signals for directly driving the shutter glasses 22.

Interleaved Stereo Mode:

A video switch 234 is coupled to receive red, green and blue VGA signal inputs from the VGA pass through circuit 201. Such inputs are provided on the lines 235, 236, 237. The video switch 234 also receives a chip select input on line 238 from the microcontroller 207 when the microcontroller detects stereo mode operation of the interleaved type. When in interleaved type operation, the VGA signals on selected lines are coupled to ground resulting in black, thereby skipping lines and allowing a signal intended for one line to be delivered to the next line on the display, thereby to expand the image. Thus, using the video switch 234, when the circuit 200 is operating in interleaved stereo mode, the video switch 234 either connects the red, green and blue VGA signals to the video output, i.e., the VGA output 203, or couples those signals to ground causing a black output and, thus, allowing for alternate images shown on the display to be respectively left eye and right eye images.

Also note that if the micro controller 207 detects operation in the stereo interleaved mode, then the video switch 234 is operated by the micro controller 207 selectively to blank (black out) alternate lines so that odd lines of data received from the VGA card are delivered to be written for display on the display to present one eye image and even lines are delivered to provide the other eye image, and so on sequentially.

Top/Bottom Stereo Mode:

The circuit 200 also includes an exclusive OR gate 250 which intercepts the vertical sync signal on line 230. The exclusive OR gate is coupled to line 230 and also to a line 251 from a vertical sync generator output of the microcontroller 207. The exclusive OR gate is for use when the type of stereo mode is the top and bottom type. The exclusive OR gate exclusive OR's the vertical sync signal on line 230 and the vertical sync generator output from the microcontroller provided on line 251. The output on line 252 from the exclusive OR gate 250 is provided to the output VGA connector 203 where it is expected that a vertical sync signal ordinarily would appear. When the microcontroller 207 has not detected above and below stereo mode, the signal on line 251 from the vertical sync generator from the microcontroller 207 will not affect the output of the exclusive OR gate 250; rather, the output on line 252 will be the same vertical sync signal as appears on line 230. However, if the microcontroller 207 detects stereo operation of the above and below type, then the signal on line 251 will have an affect on the output 252 from the exclusive OR gate 250.

More particularly, if top bottom mode is detected, then the micro controller 207 generates an additional vertical sync signal on line 251 and in effect inserts it via the exclusive OR gate 250 for delivery to line 252. Such additional vertical sync causes lines to be skipped as the image data is written to the display screen 13. Therefore, after one full screen in effect is written using for display only the image data from the top half of the data frame; and the next full screen in effect is written using only image data from the bottom half of the image data frame, and so forth.

Note that if the micro controller 207 detects operation in stereo page flip mode it does not cause any additional vertical sync signals to be inserted; rather, the VGA signals are delivered to the display 13 in usual manner. One page or field represents one eye image and the next field represents the other eye, and so on sequentially.

### Industrial Application

The invention may be used to view stereoscopic images and to control the displaying of stereoscopic images.

What is claimed follows:

1. A stereoscopic liquid crystal eyewear system comprising:
liquid crystal eyewear for viewing an image; and
an electronic circuit including a coordination circuit portion and a transmitter circuit portion,
wherein the coordination circuit portion provides a delay to accommodate the switching time and latency of the liquid crystal eyewear, and
wherein the transmitter circuit portion generates a signal for transmission to the liquid crystal eyewear.

2. The system of claim 1, wherein the delay is for about 150 μS.

3. The system of claim 1, wherein the transmission is a wireless transmission.

4. The system of claim 3, wherein the wireless transmission is an infrared wireless transmission.

5. The system of claim 4, wherein the infrared wireless transmission includes the generation of light pulses for about 60 μS or less.

6. The system of claim 4, wherein infrared signals produced to provide the infrared wireless transmission are sufficiently spaced apart and have a duration sufficiently short to avoid interfering with infrared equipment that uses infrared signals lasting hundreds of milliseconds.

7. The system of claim 6, wherein the infrared equipment includes an infrared remote control.

8. The system of claim 3, further comprising plural infrared transmitters to generate the infrared wireless transmission.

9. The system of claim 8, wherein at least two of the plural infrared transmitters are positioned to have different fields of view.

10. The system of claim 1, wherein the liquid crystal eyewear alternate states and a timing of the alternating states is periodically synchronized to a synchronization signal.

11. The system of claim 1, wherein the electronic circuit further includes another circuit portion to filter a synchronization signal.

12. The system of claim 11, wherein the another circuit portion includes a transistor.

13. The system of claim 11, further comprising internal and external oscillators, the external oscillator is external to the electronic circuit and helps to generate the synchronization signal which is coupled to the another circuit portion.

14. The system of claim 11, wherein the electronic circuit has an internal oscillator and receives the synchronization signals without filtering.

15. The system of claim 1, wherein the liquid crystal eyewear uses liquid crystal driving voltages of kX and −X, wherein k is a non-zero constant and X is a non-zero voltage.

16. The system of claim 15, wherein k=2 and X=±5.

17. The system of claim 15, wherein the net applied voltage is 0.

18. The system of claim 1, wherein the delay includes transmission time through the electronic circuit.

19. The system of claim 1, wherein a circuit for driving liquid crystal eyewear is part of a frame of the liquid crystal eyewear.

20. A method of controlling stereoscopic liquid crystal eyewear comprising:
periodically altering a transmissive state of the stereoscopic eyewear, a timing of the periodically altering the transmissive state of the stereoscopic eyewear corresponding to a first synchronizing signal;
monitoring a second synchronizing signal to determine a period of the second synchronization signal;
subtracting a latency of the liquid crystal eyewear from the period to determine a switching interval; and
transmitting a first synchronizing signal to control the timing of the periodically altering of the periodically altering the transmissive state of the stereoscopic eyewear,
wherein the first synchronizing signal is determined in accordance with the switching interval.

21. The method of claim 20, wherein transmitting a second synchronizing signal is substantially the first synchronizing signal with a time delay substantially equal to the switching interval.

22. A control circuit for controlling light shutters used to view stereoscopic images, comprising
a signal source providing a synchronizing signal representative of the presenting of left and right eye images for selective viewing to provide a stereoscopic view,
a time shifter to shift the timing of the synchronizing signal to compensate for latency characteristics.

23. The circuit of claim 22, wherein the latency characteristics are in at least one of the light shutters and circuitry used to operate light shutters.

24. The circuit of claim 22, wherein the time shifter advances the synchronizing signal or a signal produced based on the synchronizing signal to commence operation of at least one of the operation of the light shutters and circuitry used to operate the light shutters.

25. The circuit of claim 22, wherein the signal source is a periodic waveform and the time shifter subtracts from the periodic waveform time at which sequential transitions occur in the periodic waveform so the advanced transitions occur to cause light shutters to be ready to transmit or to block light, respectively, according to timing of the availability of a respective image for viewing.

26. The circuit of claim 25, wherein the subtracted amount of time is from about several microseconds to several hundred microseconds.

27. The circuit of claim 22, further comprising a signal sharpening circuit for sharpening the synchronizing signal to closely approximate a square wave.

28. The circuit of claim 22, wherein the time shifter comprises a micro controller.

29. The circuit of claim 28, further controlling an oscillator for supplying a periodic input to the micro controller for stepping the micro controller through its programmed functions to subtract time from the synchronizing signal for delivery of an output to shutters.

30. The circuit of claim 28, wherein the micro controller includes a timer operative based on a periodic input to determine whether it is logical that a received signal is the synchronization signal providing transitions when expected.

31. The circuit of claim 30, further comprising an oscillator for providing a timing input to the micro controller.

32. The circuit of claim 22, wherein the time shifter comprises a micro controller and a multiplexer/demultiplexer.

33. The circuit of claim 32, further comprising a voltage increasing circuit providing a voltage for delivery by the multiplexer/demultiplexer to shutters to provide power selectively to operate the shutters sequentially.

34. The circuit of claim 33, wherein the micro controller controls operation of the multiplexer/demultiplexer sequentially to provide power to operate respective shutters.

35. The circuit of claim 22, wherein a VGA circuit card provides input to the circuit, including power and synchronization signals.

36. A viewing system for viewing a sequence of left eye images and right eye images to provide a stereoscopic view, comprising light shutters for sequentially transmitting sequential images for viewing, respectively, by a left eye and right eye of a user, and the circuitry of claim 21.

37. The system of claim 36, the shutters comprising liquid crystal shutters.

38. The system of claim 37, wherein the shutters are mounted in a frame for positioning on the head of a user.

39. The system of claim 37, further comprising a photodetector for detecting signals from the circuit for controlling operation of the shutters.

40. The system of claim 39, the photodetector comprising an infrared sensing photodetector.

41. The system of claim 39, wherein the circuit includes a light emitter for providing light pulses for detection by the photodetector.

42. The system of claim 41, wherein the light emitter provides such light pulses in relation to the time shifted synchronization signal.

43. The system of claim 41, wherein the light emitter comprises two light emitting diodes.

44. The system of claim 43, wherein the circuit comprises a charge storage circuit for delivering signals to the light emitting diodes to produce sharp fast light pulses in correlation to the time shifted synchronization signal.

45. The system of claim 37, wherein the time shifter subtracts from the timing of the synchronization signal time to account for latency in at least one of the shutters and transmission time for a signal to be provided to at least one of the shutters to cause a change in the light transmitting or light blocking state thereof.

46. The system of claim 45, wherein the shutters are liquid crystal shutters and further comprising a least one light emitting diode for transmitting light to a photosensor associated with the liquid crystal shutters to cause synchronization of the liquid crystal shutters with the time shifted synchronization signal.

47. The system of claim 46, wherein the subtracted amount of time accounts for latency in the liquid crystal shutters and the operation of the at least one light emitting diode or detection of light from the light emitting diode.

48. The system of claim 46, wherein the light emitting diode is an infrared emitting light emitting diode and the photosensor senses infrared electromagnetic energy.

49. The system of claim 45, wherein the time shifter precludes delivering of signals to synchronize or to control the shutters until at least an adequate amount of time has expired in relation to the duration of respective images presented for viewing through the respective shutters.

50. The system of claim 36, further comprising a light emitting diode to provide light output pulses for synchronizing operation or for operating at least one shutter, and further comprising a charge storage circuit for delivering signals to the light emitting diode to produce sharp fast light pulses in correlation to the time shifted synchronization signal.

51. The system of claim 36, further comprising a noise rejection circuit to preclude unexpected signals from causing an output to the shutters.

52. The system of claim 36, wherein signals based on the operation of the time shifter are provided by wire connection to the shutters to operate the shutters in time synchronization with the providing of respective left and right eye images for viewing through respective shutters.

53. The system of claim 36, wherein the shutters are in a mounting structure, an operating circuit and power source are mounted with respect to the mounting structure, a photosensor is mounted with respect to the mounting structure and provides input to the circuit to control operation of the shutters, and a wireless source provides a signaling function to the photosensor to operate the shutters based on signals developed in the control circuit.

54. The system of claim 53, wherein the operating circuit comprises a switch, and wherein the photosensor provides an input to the switch to cause operation of the shutters sequentially to transmit light and to block light transmission.

55. The system of claim 53, wherein the wireless source comprises an infrared source.

56. The system of claim 53, wherein the mounting structure is a head mount frame.

57. The system of claim 53, wherein the mounting structure is an eyeglasses frame.

58. The system of claim 53, wherein the shutters are liquid crystal shutters.

59. The system of claim 36, wherein the time shifter comprises a micro controller and a multiplexer/demultiplexer.

60. The system of claim 59, further comprising a voltage increasing circuit providing a voltage for delivery by the multiplexer/demultiplexer to shutters to provide power selectively to operate the shutters sequentially.

61. The System of claim 60, wherein the micro controller controls operation of the multiplexer/demultiplexer sequentially to provide power to operate respective shutters.

62. The system of claim 36, wherein a VGA circuit card provides input to the circuit, including power and synchronization signals.

63. A circuit for supplying signals to operate shutters sequentially to provide selective transmission and blocking of images for sequential viewing to provide a stereoscopic images, comprising
a controller producing a time shifted periodic signal based on an input synchronization signal,
a multiplexer/demultiplexer responsive to an output from the controller for sequentially providing power signals to operate respective shutters for such viewing stereoscopic images.

64. The circuit of claim 63, further comprising a voltage increaser for increasing the magnitude of the power signals.

65. The circuit of claim 64, further comprising a connection to a computer to receive from the computer power and synchronization signals, and wherein the voltage increaser is a voltage doubler that increases such power signal for delivery via the multiplexer/demultiplexer to the shutters.

66. The circuit of claim 63, wherein the controller is a micro controller and the micro controller is coupled to control timed operation of the multiplexer/demultiplexer to operate the shutters.

67. The circuit of claim 63, wherein the micro controller and multiplexer/demultiplexer are coordinated to provide a net DC voltage of zero volts to avoid polarizing the shutters.

68. The circuit of claim 63, wherein a VGA circuit card provides input to the circuit, including power and synchronization signals.

69. A viewing system for viewing a sequence of left eye images and right eye images to provide a stereoscopic view, comprising light shutters for sequentially transmitting sequential images for viewing, respectively, by a left eye and right eye of a user, and the circuitry of claim 2 for providing power to operate the light shutters.

70. The system of claim 69, wherein the controller and multiplexer/demultiplexer are coordinated to provide a net DC voltage of zero volts to avoid polarizing the shutters.

71. The system of claim 69, wherein a VGA circuit card provides input to the circuit, including power and synchronization signals.

72. A modular system for viewing stereoscopic images characterized in that an image source provides sequentially images for viewing respectively by the respective eyes of a viewer to create the impression of a stereoscopic view, selectively operable shutters to transmit or to prevent transmission of images, a signal source provides synchronization signal for synchronizing the shutters, and a wired or wireless connection is provided to the shutters for operation thereof in response to such synchronization.

73. The system of claim 72, further characterized in that the signals provided the shutters are advanced to accommodate latency characteristics of at least part of the system.

74. The system of claim 72, further characterized in that the shutters are in a head mounted support, a receiver is associated with the shutters to receive signals from a transmitter representing the synchronization signal to operate the shutters in coordination with the respective images provided for viewing.

75. The system of claim 74, further characterized in that the signals provided the shutters are advanced to accommodate latency characteristics of at least part of the system.

76. The system of claim 74, further comprising a battery and a power circuit for delivering power to respective shutters under controlled operation by the signal received by the receiver.

77. The system of claim 76, wherein the transmitter transmits infrared light, and the photosensor detects such infrared light.

78. The system of claim 74, further characterized in that a free running circuit operates the shutters and the signal detected by the photosensor provides for synchronization of the shutters with respect to respective left and right eye view displayed images.

79. The system of claim 74, further characterized in that the duty cycle of synchronization signals from the transmitter is significantly shorter than the duty cycle of television infrared remote control devices.

80. The system of claim 72, further characterized in comprising a display for presenting the images.

81. The system of claim 80, further characterized in comprising an image source.

82. The system of claim 81, further characterized in that the image source is provided via a network.

83. The system of claim 81, further characterized in that the image source is provided by a gaming electronic device.

84. The system of claim 81, further characterized in that the image source is provided by a television.

85. The system of claim 81, further characterized in that the image source is a computer.

86. The system of claim 80, further characterized in that the duration of respective signals to the photosensor is of substantially shorter duration than infrared control signals for television apparatus.

87. The system of claim 86, further characterized in that the respective signals to the photosensor are on the order of about 60 microseconds duration.

88. The system of claim 87, further characterized in that the respective signals to the photosensor are provided at a frequency of occurrence of on the order of about three such signals in each five hundred millisecond time period.

89. The system of claim 72, further characterized in that for a wired connection the wire provides power signals to both the shutters for selective operation thereof.

90. Apparatus for providing signals to synchronize light shutters for viewing of stereoscopic images from a video source, comprising
a device to obtain field information from a video signal provided by a video source, wherein such field information provides coordination to the particular field of a multiple field image for display,
a controller responsive to the field information provided by the stripper to provide synchronization of light shutters to control delivery of respective images to respective eyes of a viewer.

91. The apparatus of claim 90, wherein the controller comprises a micro controller, further comprising an oscillator for providing an input to the micro controller.

92. The apparatus of claim 91, further comprising an infrared light source for providing infrared signals to a receiver in synchronism with the signals from the micro controller and field information, the receiver providing input to synchronize the shutters.

93. The apparatus of claim 92, further comprising a free running circuit to provide power to the respective shutters and wherein the receiver controls delivery of signals from the free running circuit to the respective shutters.

94. The apparatus of claim 91, further comprising a wired connection from the controller to the shutters to provide power to operate the shutters.

95. The apparatus of claim 90, wherein the synchronization is characterized in being adjusted to provide an advance in the timing thereof to reduce latency effects.

96. Apparatus for providing control signals to light shutters for operation to view stereoscopic images, comprising
a first infrared light emitting source to provide coordination signals to a receiver associated with shutters, and
a further infrared light emitting source to increase the area of coverage by infrared light to allow increase the area in which the stereoscopic images can be viewed.

97. The apparatus of claim 96, further comprising a synchronization signal source for causing operation of the infrared light emitting sources in synchronism with respective image portions of a stereoscopic image to provide for viewing of such images via the respective shutters.

98. A stereoscopic viewing system for viewing stereoscopic images provided by a source, comprising
a pair of light shutters to control delivery of respective left and right eye images for viewing as a stereoscopic image provided by an image source,
a free running drive circuit for driving the respective light shutters,
a control circuit responsive to a prescribed input for synchronizing operation of the light shutters, and
a detector for detecting incoming coded signals representing a prescribed operation of the control circuit to operate the shutters for viewing a stereoscopic image.

99. The system of claim 98, wherein the control circuit comprises a programmed application specific circuit.

100. The system of claim 98, wherein the controller includes a timer function to shut down the free running drive circuit in the absence of the controller receiving an input from the detector.

101. The system of claim 100, wherein the prescribed input is a digital word.

102. The system of claim 98, wherein the controller is responsive to the prescribed input to operate the correct respective shutter in coordination with the coded signals representative of characteristics of the image.

103. The system of claim 102, wherein the controller is responsive to shut down the shutters and the free running drive circuit in response to a prescribed input.

104. The system of claim 102, wherein the controller is responsive to maintain open both shutters in response to a prescribed input for viewing a non-stereoscopic image.

105. The system of claim 102, wherein the controller is responsive to a prescribed input to operate the shutters for timing according to the timing of video signals providing the respective stereoscopic images.

106. The system of claim 105, wherein the timing is for a PAL video signal timing format or an NTSC video signal timing format.

107. The system of claim 102, wherein the coded signals are at least one of number of pulses, duration of respective pulses, and timing of pulses.

108. Apparatus for detecting characteristics of computer images and controlling a display and light shutters for viewing of such images, comprising
a detector for comparing signals representing two different colors and a reference to determine whether image signals are provided in stereoscopic pairs or planar,
a display controller for controlling delivery of such image signals to a display in a format according to the detector response, and
an output for selectively controlling light shutters for viewing stereoscopic images or planar images.

109. The apparatus of claim 108, wherein the detector compares red and green signals with a reference voltage.

110. The apparatus of claim 108, wherein the apparatus receives digital input signals and includes a digital to analog converter to provide signals for synchronous operation of the light shutters.

111. The apparatus of claim 108, wherein the apparatus receives digital input signals and includes a digital to analog converter to provide power for delivery to the light shutters to operate the light shutters for viewing respective stereoscopic or planar images.

112. The apparatus of claim 108, wherein the apparatus receives a vertical sync signal from an image providing source, and further comprising a further vertical sync generating device to generate an additional vertical sync signal to provide for spreading of images that are provided in a compressed format.

113. The apparatus of claim 112, wherein the compressed format is over and under, and wherein the vertical sync signal and the additional vertical sync signal are provided to spread the image over the display as respective sequentially provided opposite eye images for viewing by via the light shutters.

114. The apparatus of claim 112, further comprising a line blanker to blank selected lines of the display during image spreading operation.

115. A display system for displaying planar or stereoscopic images, comprising a display, a computer for providing image signals for display by the display, light shutters for viewing or blocking view of respective images presented on the display to allow viewing of planar or stereoscopic images, and the circuit of claim 108 to respond to signals from the computer to provide displayed images while coordinating operation of the light shutters for viewing of the images.
